(19) United States
(12) Patent Application Publication
(10) Pub. No.: US 2005/0070186 A1
(43) Pub. Date: Mar. 31, 2005

(54) Urea-formaldehyde binder composition and process

(75) Inventors: Kelly Shoemake, Conyers, GA (US); John Everett Thompson, Atlanta, GA (US); Robert A. Breyer, Tucker, GA (US); Jason Rivers, Atlanta, GA (US)

Correspondence Address: BANNER & WITCOFF, 1001 G STREET N W, SUITE 1100, WASHINGTON, DC, 20001, US

(73) Assignee: Georgia-Pacific Resins, Inc., Atlanta, GA (US)

(21) Appl. No.: 10/671,884

(22) Filed: Sep. 29, 2003

(51) Int. Cl. B32B 5/02; B32B 3/00

(52) U.S. Cl. 442/176; 442/59; 442/180; 528/230; 528/259; 162/164.1

(57) ABSTRACT

An aqueous binder composition containing a urea-formaldehyde resin modified with a protein, preferably with a source of soy protein and the use of the binder for preparing fiber mats, especially glass fiber mats.

### BACKGROUND OF THE INVENTION

1. Field of the Invention

This invention relates to a modified, thermosetting urea-formaldehyde resin composition useful as a binder, such as for making fiber mats, particularly glass fiber mats, to the fiber mats prepared using the modified urea-formaldehyde resin composition as a binder, and to a process of preparing the fiber mats using the binder. In particular, the invention relates to a fiber mat binder composition comprising a thermosetting urea-formaldehyde resin (UF) modified by the addition of a binding-enhancing amount of a protein, especially a soy protein.

2. Description of Related Art

Glass fiber mats, fiber mats made from synthetic fibers and mats made from fiber blends are finding increasing application in the building materials industry, as for example, as insulation, in composite flooring, in roofing shingles, or siding, replacing similar sheets traditionally made using wood, cellulose or asbestos fibers, and as a facing material for laminated articles such as foam composites and gypsum boards.

Such mats are made in a range of thickness and densities, by entangling, often short, staple fibers, long continuous fibers and mixtures thereof, generally referred to as non-woven mats.

Some non-woven fiber mats, and especially relatively thin non-woven glass fiber mats, usually are made commercially by a wet-laid process, which is carried out on what can be viewed as modified papermaking machinery. Descriptions of the wet-laid process may be found in a number of U.S. patents, including U.S. Pat. Nos. 2,906,660, 3,012,929, 3,050,427, 3,103,461, 3,228,825, 3,760,458, 3,766,003, 3,838,995, 3,905,067, 4,112,174, 4,681,802 and 4,810,576.

In general, the wet-laid process for making glass fiber mats comprises first forming an aqueous slurry of short-length glass fibers (referred to in the art as “white water”) under agitation in a mixing tank, then feeding the slurry onto a moving screen on which the fibers enmesh themselves into a freshly prepared wet glass fiber mat, while excess water is separated from the mat of fibers.

Machines such as wire cylinders, Fourdrinier machines, Stevens Former, Roto Former, Inver Former and Venti Former machines can be used to form the wet-laid mat. In such equipment, a head box deposits the slurry onto a moving wire screen. Suction or vacuum removes the water resulting in the wet-laid mat.

Unlike natural fibers such as cellulose or asbestos, glass fibers do not disperse well in water. To overcome this problem, it has been the industry practice to provide suspending aids for the glass fibers. Such suspending aids or dispersants usually are materials that increase the viscosity of the aqueous medium. Suitable dispersants conventionally employed in the art include polyacrylamides, hydroxyethyl cellulose, ethoxylated amines and amine oxides. Other additives such as surfactants, lubricants and defoamers also conventionally have been added to the white water. Such agents, for example, further aid the wettability and dispersion of the glass fibers. Experience has shown that such additives also often influence the strength of the wet glass fiber mat.

The fiber slurry deposited on the moving screen or cylinder is processed into a sheet-like fiber mat by the removal of water, usually by suction and/or vacuum devices, and is followed by the application of an adhesive binder to the mat. In the manufacture of fiber mats, a high degree of flexibility and tear strength is desired in the finished mat in addition to primary dry tensile and wet tensile properties. An adhesive binder composition is therefore used to hold the fiber mat together. The binder composition is impregnated directly into the fibrous mat and set or cured immediately thereafter to provide the desired mat integrity.

The binder composition is applied to the mat by soaking the mat in an excess of binder solution or suspension, or by impregnating the mat surface by means of a binder applicator, for example, by a roller coater, curtain coater, dip and squeeze application, or spray coater. The primary binder applicator for fiber mat machines has been the falling film curtain coater. Suction devices often are also utilized for further removal of water and excess binder and to ensure a thorough application of binder through the full thickness of the fiber mat.

A widely used binder for making fiber mats, especially glass fiber mats, is based on urea-formaldehyde resin, and often is fortified with an emulsion polymer. UF resins have commonly been employed because they are relatively inexpensive. In addition to mat strength properties which the binder composition imparts to the ultimately cured mat, the binder also functions to improve the strength of the uncured, wet-laid mat as it is transported from its initial formation into and through the curing oven. Such incipient pre-cured strength is needed to avoid process delays and shutdowns caused by breaks in the endless mat.

Thus-incorporated binder is dried and thermally cured, typically in an oven at elevated temperatures. Generally, a temperature in the range of about 200 to 400° C. is used during heating step. The necessary heat energy can be supplied in any manner known in the art including direct-fired ovens, convection ovens, or by radio frequency (RF) or dielectric heating. Normally, heat treatment alone will effect curing of the binder. Catalytic-assisted curing, such as is accomplished with addition of an acid catalyst (for example, ammonium chloride or p-toluene sulfonic acid) to the binder composition is an optional, alternative. The resulting cured mat is normally wound into rolls, packaged and shipped to a point of use.

Because fiber mats made with a binder consisting essentially of a UF resin often are brittle, or because the strength properties of the mats may deteriorate appreciably subsequent to their preparation, especially when the mats are subjected to wet conditions, UF resin binders have often been modified by formulating the UF resin with cross-linkers and various catalyst systems or by fortifying the UF resin with a large amount of latex (emulsion) polymer, usually a polyvinyl acetate, vinyl acrylic or styrene-butadiene polymer. Certain latexes can provide increased tensile strengths and tear strength. The use of styrene-butadiene latex-modified, urea-formaldehyde resin compositions as a binder for glass fiber mats is disclosed, for example, in U.S. Pat. Nos. 4,258,098; 4,560,612 and 4,917,764.

U.S. Pat. No. 5,914,365 and U.S. Pat. No. 6,084,021 describe an improved (modified) thermosetting urea-formaldehyde resin-based aqueous binder composition useful for making fiber mats, particularly glass fiber mats, modified by the addition of a water soluble styrene-maleic anhydride copolymer (SMA). To prepare the aqueous binder, a thermosetting UF resin and an SMA copolymer can simply be mixed in a desired proportion under ambient conditions.

U.S. Pat. No. 5,518,586 describes using a binder comprising urea-formaldehyde resin and a water-insoluble anionic phosphate ester and a fatty alcohol for making a glass fiber mat.

U.S. Pat. No. 5,851,933 describes preparing a non-woven fibrous mat with a binder made from a urea/formaldehyde resin modified with a self crosslinkable vinyl acrylic/polyvinyl acetate copolymer.

U.S. Pat. No. 6,384,116 describes a binder composition for making glass fiber mats in which a water soluble non-ionic amine oxide is used to modify a UF resin and is optionally used in combination with an anionic acrylic latex, a water soluble polymer based on a polymerized ethylenically unsaturated carboxylic acid monomer or their mixture. This patent also presents a useful discussion of glass fiber mat production and for that reason is incorporated by reference herein in its entirety.

U.S. Pat. No. 6,544,911 describes preparing a fibrous mat using a binder of a urea/formaldehyde resin containing a styrene/acrylate/acrylonitrile polymer modifier supplemented with a polysiloxane.

Despite these disclosures, there is a continuing need for identifying new aqueous compositions suitable for use as a binder for fiber mats, especially for making glass fiber mats that provide improvements in mat tensile properties.

### BRIEF DESCRIPTION OF THE INVENTION

The invention is directed to an aqueous binder composition for fiber mats principally based on a thermosetting urea-formaldehyde (UF) resin. The invention is more specifically directed to an aqueous binder composition containing as its major component a thermosetting, UF resin and as a minor, modifying component a protein, preferably a vegetable protein and especially a soy protein. The invention also is directed to a process for preparing fiber mats, particularly glass fiber mats, using the binder, and to fiber mats produced by the method. Thin mats made using this binder are useful, for example, as substrates in the manufacture of roofing shingles and composite flooring.

This invention is based on the discovery that by adding an effective, binding-enhancing amount of a protein, preferably a vegetable protein and especially a soy protein, to a thermosetting urea-formaldehyde (UF) resin-based binder and using the modified composition as a fiber mat binder, fiber mats having suitable tensile and tear strength properties can be produced. Glass fiber mats made using the modified binder composition of the present invention exhibit wet tensile strengths, tear strengths, and dry tensile strengths substantially equivalent to mats made with prior art UF resin binders modified with synthetic additives. These are all desirable properties of fiber mats, especially glass fiber mats used in the roofing products industry, such as for making asphalt shingles.

Interest has again been on the increase for finding ways to reduce the usage of petroleum-based raw materials. Sources of soy protein, in particular, are being reconsidered as an alternative ingredient in adhesive compositions to reduce the reliance on petroleum-based polymers and to reduce environmental pollution. The present invention is based on the discovery that by adding a small, binding-enhancing amount of a protein, preferably a vegetable protein and especially a soy protein, to a UF resin-based binder, fiber mats having commercially acceptable tensile and tear properties can be made using the binder.

In manufacturing fiber mats in accordance with the invention, fibers, e.g., inorganic fibers such as glass fibers or mineral fibers, or synthetic fibers, or fiber blends are slurried into an aqueous medium. As noted above, the aqueous medium also typically contains a dispersant for facilitating formation of the fiber slurry. Dispersants such as polyacrylamides, hydroxyethyl cellulose, ethoxylated amines and amine oxides are common, though the present invention should not be limited to any specific dispersant/viscosity enhancer package. The fiber slurry then is dewatered on a foraminated surface to form a wet fiber mat. The modified, UF resin binder of the invention then is applied to the wet mat before it passes through a drying (curing) oven, where the fiber mat is dried and any incorporated binder resin composition is cured. Fiber mats produced in accordance with the invention exhibit acceptable wet mat strength, good dry and wet tensile strength and superior tear strength.

### DETAILED DESCRIPTION OF THE INVENTION

As used herein the phrases “glass fiber,” fiberglass” and the like are intended to embrace heat-resistant fibers suitable for withstanding elevated temperatures such as mineral fibers, aramid fibers, ceramic fibers, metal fibers, carbon fibers, polyimide fibers, certain polyester fibers, rayon fibers, and especially glass fibers. Such fibers are substantially unaffected by exposure to temperatures above about 120° C. If intended to embrace predominately and/or only fibers made from glass, i.e., a material made predominately from silica, then a phrase such as “principally glass fiber” or “only glass fiber,” respectively will be used.

The process of forming a fiber mat, and especially a glass fiber mat in accordance with the present invention generally begins with fibers of suitable length and diameter for the intended application, such as chopped bundles of glass. While reference is made hereinafter to using chopped bundles of glass fibers, other fiber types, e.g., mineral fibers, synthetic fibers, such as polyethylene, polypropylene, polyester and nylon fibers, and mixtures of various fiber types, and other forms of fibers such as continuous strands, may also be used.

Generally, fibers having a length of about ¼ inch to 5 inches (about 6 to about 140 mm) and a diameter of about 3 to 25 microns are used for most non-woven mat applications. Short and long fibers can be mixed to form a mat web of increased fiber entanglement. Glass fiber bundles, which may contain from about 20 to 500, or more, of such fibers, are available commercially from Owens-Corning Fiberglass and Johns-Manville (Schuller).

The fibers are added to an aqueous dispersant medium to form an aqueous slurry, known in the art as “white water.” The white water typically contains about 0.5% fibers. Any viscosity modifier or dispersant, including those commonly used in the past, can be used in the practice of the present invention including hydroxyethyl cellulose, ethoxylated amines, polyacrylamides, amine oxides and the like. Again, the present invention is not limited to any specific viscosity modifier. A polyacrylamide white water system has proven to be compatible with the binder composition of the present invention. The amount of viscosity modifier used should be effective to provide the viscosity needed to suspend the fibers in the white water as needed to practice the method used to form the wet laid mat. The white water viscosity is generally in the range of 1 to 20 cps, preferably 1.5 to 8 cps. The fiber slurry then is agitated to form a workable, uniform dispersion of fibers having a suitable consistency. The viscosity modifier also may contain other conventional additives known in the art. These include dispersion aids, surfactants, lubricants, defoamers and the like.

The fiber/water dispersion then is passed to a mat-forming machine typically containing a mat-forming screen. On route to the screen, the dispersion often is diluted further with water to a lower fiber concentration. The fibers are collected at the screen in the form of a wet fiber mat and excess water is removed by gravity or, more often, by vacuum assist in a conventional manner.

The binder composition of the invention then is applied to the gravity- or vacuum-assisted dewatered wet fiber mat. Application of the binder composition may be accomplished by any conventional means, such as by soaking the mat in an excess of binder solution or suspension, or by coating the mat surface with binder by means of a binder applicator, such as a falling film or curtain coater.

The thermosetting urea-formaldehyde (UF) resin used as the major component of the binder composition of the present invention can be prepared from urea and formaldehyde monomers or from UF precondensates in manners well known to those skilled in the art. Suitable resins are commercially available and the present invention can advantageously be applied to all UF resin compositions suitable for making binder compositions for fiber mats. Skilled practitioners recognize that the urea and formaldehyde reactants are commercially available in many forms. Any form which can react with the other reactants and which does not introduce extraneous moieties deleterious to the desired reaction and reaction product can be used in the preparation of urea-formaldehyde resins useful in the invention.

One useful class of UF resins for use in preparing binders in accordance with the present invention is disclosed in U.S. Pat. No. 5,362,842, the disclosure of which is incorporated herein by reference.

As well-understood by those skilled in the art, formaldehyde for making a suitable UF resin is available in many forms. Paraform (solid, polymerized formaldehyde) and formalin solutions (aqueous solutions of formaldehyde, sometimes with a small amount of methanol, in 37 percent, 44 percent, or 50 percent formaldehyde concentrations) are commonly used forms. Formaldehyde also is available as a gas. Any of these forms is suitable for use in preparing a UF resin in the practice of the invention. Typically, formalin solutions are preferred as the formaldehyde source for ease of handling and use.

Similarly, urea is available in many forms. Solid urea, such as prill, and urea solutions, typically aqueous solutions, are commonly available. Further, urea may be combined with another moiety, most typically formaldehyde and urea-formaldehyde adducts, often in aqueous solution. Any form of urea or urea in combination with formaldehyde is suitable for use in the practice of the invention. Both urea prill and combined urea-formaldehyde products are preferred, such as Urea-Formaldehyde Concentrate or UFC 85. These types of products are disclosed in, for example, U.S. Pat. Nos. 5,362,842 and 5,389,716 and are well known to skilled workers.

Any of the wide variety of procedures used for reacting the principal urea and formaldehyde components to form an aqueous UF thermosetting resin composition also can be used, such as staged monomer addition, staged catalyst addition, pH control, amine modification and the like. The present invention is not to be limited to a restricted class of UF resins for making fiber mats. Generally, the urea and formaldehyde are reacted at a mole ratio of formaldehyde to urea in the range of about 1.1:1 to 4:1, and more often at an F:U mole ratio of between about 2.1:1 to 3.2:1. Generally, the U-F resin is highly water dilutable, if not water soluble.

Following synthesis of the UF resin and as part of the formulation of the binder composition of the present invention, it is common to back-add additional urea to the resin composition. Any form of urea can be used, including UF concentrates. As a consequence of such post-synthesis modifications the F:U mole ratio of the final binder composition is typically in the range of about 1.4:1 to about 2.3:1, depending on the final product requirements as known to those skilled in the art.

Many thermosetting urea-formaldehyde resin compositions, which may be used in the practice of this invention, are commercially available. Urea-formaldehyde resins such as the types sold by Georgia Pacific Resins, Inc. (available as GP-2928, GP-2948 and GP-2981) for glass fiber mat applications, those sold by Borden Chemical Co., and by Dynea may be used. These resins are prepared in accordance with the previous teachings and contain reactive methylol groups, which upon curing form methylene or ether linkages. Such methylol-containing adducts may include N,N′-dimethylol, dihydroxymethylolethylene; N,N′bis(methoxymethyl), N,N′-dimethylolpropylene; 5,5-dimethyl-N,N′dimethylolethylene; N,N′-dimethylolethylene; and the like.

Urea-formaldehyde resins useful in the practice of the invention generally contain 45 to 75%, and preferably, 55 to 65% non-volatiles, generally have a viscosity of 50 to 600 cps, preferably 150 to 400 cps, normally exhibit a pH of 7.0 to 9.0, preferably 7.5 to 8.5, and often have a free formaldehyde level of not more than about 3.0%, often less than 1%, and a water dilutability of 1:1 to 100:1, preferably 5:1 and above.

The reactants for making the UF resin may also include a small amount of resin modifiers such as ammonia, alkanolamines, or polyamines, such as an alkyl primary diamine, e.g., ethylenediamine (EDA). Additional modifiers, such as melamine, ethylene ureas, and primary, secondary and tertiary amines, for example, dicyanodiamide, can also be incorporated into UF resins used in the invention. Concentrations of these modifiers in the reaction mixture often will vary from 0.05 to 20.0% by weight of the UF resin solids. These types of modifiers promote hydrolysis resistance, polymer flexibility and lower formaldehyde emissions in the cured resin. Further urea additions for purposes of scavenging formaldehyde or as a diluent also may be used.

The second component of the aqueous binder composition of this invention is a protein. The invention is based on the discovery that adding an effective, binding-enhancing amount of a protein, preferably a vegetable protein and especially a soy protein, to any thermosetting urea-formaldehyde (UF) resin, a binder suitable for making fiber mats of acceptable tensile and tear strength properties can be produced. Sources of such proteins are well known to those skilled in the art. The protein may be an animal protein such as soluble blood (e.g., blood albumen) or casein, or it may be a vegetable protein such as soybean (soy) or zein flour (corn).

Vegetable protein is preferred and a particularly preferred protein source is soy protein. The vegetable protein material can be in the form of ground whole beans (including the hulls, oil, protein, minerals, etc.), a meal (extracted or partially extracted), a flour (i.e., generally containing less than about 1.5% oil and about 30-35% carbohydrate), or an isolate (i.e., a substantially pure protein flour containing less than about 0.5% oil and less than about 5% carbohydrate). As used herein in the specification and claims, “flour” includes within its scope material that fits both the definitions of flour and isolate. Preferably, the vegetable protein is in the form of a protein flour, at least because the binder and related fiber mat products produced from the binder made with a flour, as opposed to a meal, have more desirable physical properties.

Any source of soy protein (such as soybean concentrate or soybean meal) is suitable for use as the binder modifier in the present invention. Protein-rich soybean-derived flours, such as soy protein isolate, protein concentrate and ordinary defatted soy flour, which contain in the range of about 20-95% protein, should each be suitable. Of these, ordinary soy flour is the most abundant and cost-effective. The source of soy protein is preferably essentially free of functional urease.

Other proteinaceous materials useful as the modifier in this invention, in addition to the aforementioned animal and milk byproducts and soy and corn vegetable protein include, to the extent they contain protein, flours made from other varieties of other leguminous beans and seeds, such as sunflower and rape-seeds.

Information on soy protein can be found in, for example, Kirk-Othmer, Encyclopedia of Chemical Technology, Fourth Edition, Volume 22, pp. 591-619 (1997).

Preferably, the vegetable protein has a particle size (as determined by the largest dimension) of less than about 0.1 inch (0.25 cm), and more preferably less than about 0.05 inch (0.125 cm). If the particle size is much larger than this, the protein material may not be sufficiently soluble or dispersible to produce a binder suitable for making fiber mats with optimum properties. As a consequence, the resultant fiber mats may have lessened tensile properties and less visual asthetics. In those embodiments where the protein is blended with the resin before application to the fiber mat, the time required to solubilize the material tends to be undesirably longer with larger particles. Alternatively, if the protein is applied to the wet-laid mat separate from the remaining components of the binder, one may not get a smooth, asthetically acceptable cured mat using larger sized particles.

For these reasons, a protein flour is more preferred because of its generally smaller particle size distribution. That is, the most preferred ground vegetable protein has a maximum particle size of that of a flour, i.e., about 0.005 inch (0.013 cm). There does not appear to be a minimum particle size requirement for the ground vegetable protein; however, the particle size of commercially available soybean flour is generally less than about 0.003 inch (0.008 cm). For example, in some commercially available soybean flour, greater than about 92% passes through a 325 mesh screen, which corresponds to a particle size of less than about 0.003 inch (0.008 cm). Thus, a wide range of soy flours are expected to be suitable, such as a flour having at least 90 to 95% of its particles smaller than 100 mesh, smaller than 200 mesh, or smaller than 400 mesh.

To prepare the aqueous binder, it is possible to simply add the protein to a previously prepared aqueous thermosetting UF resin in a desired proportion and under ambient conditions. Alternatively, it also is possible to include the protein in the reaction mixture at some point during the time period in which the UF resin is prepared, for example during the methylolation step, during the condensation portion of the UF synthesis or later when taking steps to reduce free formaldehyde. In other embodiments, the protein may be applied to the fiber mat separate from the UF resin, for example by including it in the water (commonly referred to as white water) used to form the mat of fibers, or by spraying a solution or dispersion of the protein onto the mat prior to, or after application of the binder to the mat, but all before heating the mat to dry/cure the binder in the presence of the protein. Thus, in the broad practice of the present invention, any way of combining the protein with the UF resin before curing the binder, such as on the fiber mat, can be used. The aqueous, protein-modified UF resin typically has a Brookfield viscosity in the range of 50 to 600 cps at a solids content of 45 to 70%. As known to those skilled in the art, when used as a binder for making fiber mats, the resin typically is diluted, often to approximately 23% solids, before use.

In order to insure suitable storage stability of the modified binder composition and proper performance during use of the binder composition, it is desirable that the pH of the aqueous binder be adjusted to a pH within the range of about 6 to 9, and more preferably between about 7 and 8.5. Too low a pH may cause premature curing of the UF resin and incompatibility of the two constituents; while too high a pH may retard curing of the composition on heating when it is used.

Suitable binders can be prepared by including an amount of protein with the UF resin to provide, on a solids basis, a weight ratio of UF resin solids to protein solids (UF:Protein) between about 99.9:0.1 and about 90:10, usually, between about 99.9:0.1 and 90.5:9.5, preferably between about 99.8:0.2 and about 93:7 and most often in the range of 99.5:0.5 and about 95:5.

The total concentration of non-volatile components in the aqueous binder composition (predominantly UF resin and protein solids) also can vary widely in accordance with the practice of the present invention, but it will usually be found convenient and satisfactory to make up this composition at total solids concentration in the range from about 5 to about 40 percent by weight of the total aqueous binder composition. Total solids from about 20 to about 35 percent by weight are usually preferred by those using the binder for making fiber mats. As used herein, the solids content of a composition is measured by the weight loss upon heating a small, e.g., 1-5 gram sample of the composition at about 105° C. for about 3 hours.

The binder composition may also contain a variety of other known additives such as a silica colloid to enhance fire resistance, antifoamers, biocides, pigments, and the like, normally in small proportions relative to the required UF resin and protein constituents. As noted above, following synthesis of the UF resin and as part of the formulation of the binder composition of the present invention, it also is common to back-add additional urea to the resin composition. Any form of urea can be used, including UF concentrates. It also is expected that other known adjuvants, such as the styrene-maleic anhydrde (SMA) copolymers of U.S. Pat. No. 5,914,365, the non-ionic amine oxide, optionally with a latex or a water-soluble polymer, of U.S. Pat. No. 6,384,116, the water-insoluble anionic phosphate ester and a fatty alcohol of U.S. Pat. No. 5,518,586, the self crosslinkable vinyl acrylic/polyvinyl acetate copolymer of U.S. Pat. No. 5,851,933 and the styrene/acrylate/acrylonitrile polymer modifier, supplemented with a polysiloxane of U.S. Pat. No. 6,544,911 all of which are incorporated herein by reference, also can be added with improved results to make the binder composition.

The amount of binder applied to the mat also can vary considerably in the broad practice of the present invention, but loadings in the range of about 3 to about 45 percent by weight, preferably about 10 to about 40 percent by weight, and more usually about 15 to about 30 percent by weight, of nonvolatile binder composition based on the dry weight of the bonded mat, will be found advantageous in preparing thin mats for construction-related applications. For inorganic fibrous mats, this value can normally be confirmed by measuring the percent loss on ignition (LOI) of the fiber mat product.

As indicated earlier, the binder composition of this invention can be employed with any of the wide variety of fibers that can be formed into mats in any suitable manner. The fibers may be organic or inorganic, preferably inorganic fibers are used. Inorganic fibers include, but are not limited to, glass fibers, mineral fibers, ceramic fibers, graphite fibers, metal fibers and metal coated glass or graphite fibers. Asbestos fibers also could be used, but are normally undesirable for health reasons. Organic fibers include, but are not limited to, acrylic, aromatic polyamide, polyester, cellulosic fibers, and polyolefin fibers. Inorganic fibers and especially glass fibers are generally preferred.

The binder composition of the invention sets or cures at elevated temperatures below the decomposition temperature of the UF resin and protein components. The setting or curing of the binder composition normally can occur at temperatures from about 135° C. to about 300° C., preferably from about 135° C. to about 275° C. At these temperatures, the binder composition will typically dry and cure in periods ranging from about 2 seconds to about 60 seconds. Although the binder composition may cure more rapidly at higher temperatures, excessively high temperatures can cause deterioration of the binder composition or the fibers of the mat, which in turn causes a deterioration of the bonded mat physical and functional properties. Of course, lower temperatures and/or longer times can also be employed if desired.

By adding a catalyst to a UF resin, the rate of cure of the binder also can be adjusted to essentially any desired speed. UF resin binders may even be cured at ambient temperatures by catalysis with free acid. Oftentimes, a combination of a moderate increase in acidity and an elevated temperature is employed to cure the binder. A latent catalyst, or a free acid, may be added if faster cure speeds are required. Latent catalysts commonly employed include amine-acid salts, such as NH₄Cl and (NH₄)₂SO₄, which react with free formaldehyde generated during cure, and subsequently release free acid. Other non-buffering inorganic salts also can be used to enhance cure speed.

Following application of the aqueous binder composition to the wet laid mat, the glass fiber mat generally is dewatered, normally under vacuum, to remove excess binder solution. The mat then is dried and the incorporated binder composition is cured in an oven at the noted elevated temperatures for a time sufficient to cure the resin. The amount of time needed to cure the resin is readily determinable by the skilled practitioner. Heat treatment alone normally is sufficient to effect curing. Alternatively, catalytic curing in the absence of heating, or under reduced heating, may be used, such as is accomplished upon the addition of an acid catalyst, e.g., ammonium chloride or p-toluene sulfonic acid.

As used herein, “curing,” “cured” and similar terms are intended to embrace the structural and/or morphological change which occurs in the aqueous binder of the present invention as it is dried and then heated to cause the properties of a flexible, porous substrate, such as a mat of fibers, especially glass fibers, to which an effective amount of the binder has been applied, to be altered such as, for example, by covalent chemical reaction, ionic interaction or clustering, improved adhesion to the substrate, phase transformation or inversion, and hydrogen bonding.

The finished glass mat product generally contains between about 55% and 97% by weight fibers, usually glass fibers, and between about 3% and 45% by weight of cured binder, 15-30% of binder being most preferable.

The modified UF resin binder of this invention may also have application in the manufacture of fiberglass insulation.

Fiberglass insulation is typically made by spraying a dilute aqueous solution of the resin binder onto a moving mat or blanket of non-woven glass fibers, often hot from being recently formed, and then heating the mat or blanket to an elevated temperature in an oven to cure the resin.

A binder solution for making fiberglass insulation in accordance with the present invention can be blended with other ingredients and diluted to a low concentration that is readily sprayed onto the fibers as they fall onto a collecting conveyor. In the preparation of fiberglass insulation, the binder composition is generally applied in an amount such that the cured binder constitutes about 5 wt. % to about 15 wt. % of the finished fiberglass insulation. Optimally, the amount of binder for most thermal insulation products will be the amount necessary to lock each fiber into the mass by bonding the fibers where they cross or overlap. For this reason, it is desired to have binder compositions with good flow characteristics, so that the binder solution can be applied to the fiber at a low volume that will flow to the fiber intersections.

The ultimate binder composition for application to the glass fibers may comprise a variety of liquid forms, including solutions, miscible liquids, or dispersions and the like and combinations of such liquid forms depending upon the optional ingredients blended into the binder composition. Where the term solution or any of the variations thereof is used herein it is intended to include any relatively stable liquid phase.

Other conventional binder additives used when making fiberglass insulation also may be added to the binder destined for application to the glass fibers. Such additives include such conventional treatment components as, for example, silane coupling agents, emulsifiers, pigments, fillers, anti-migration aids, curing agents, coalescents, wetting agents, dedusting agents, biocides, plasticizers, anti-foaming agents, colorants, waxes, and anti-oxidants.

Processes for making fiberglass insulation products using the binder of the present invention are typically carried out according to one of a number of methods wherein a molten mineral material flowing from a melting furnace is divided into streams and attenuated into fibers. The attenuation can be done by centrifuging and/or fluid jets to form discontinuous fibers of relatively small dimensions which typically are collected by randomly depositing on a moving foraminous (porous) conveyor belt. The fibers are collected in a felted haphazard manner to form a mat. The volume of fiber in the mat will be determined by the speed of fiber formation and the speed of the belt.

Continuous glass fibers also may be employed in the form of mats or blankets fabricated by swirling the endless filaments or strands of continuous fibers, or they may be chopped or cut to shorter lengths for mat or batt formation. Use can also be made of ultra-fine fibers formed by the attenuation of glass rods. Also, such fibers may be treated with a size, anchoring agent or other modifying agent before use.

In order to produce fiberglass thermal insulation products, the fibers must be bonded together in an integral structure. To achieve this binding, the curable binder material of the present invention is applied to the glass fiber mat or blanket. When making fiberglass insulation, the layer of fiber with binder is then mildly compressed and shaped into the form and dimensions of the desired thermal insulation product. The insulation product then is passed through a curing oven where the binder is cured fixing the size and shape of the finished insulation product.

The binder composition may be applied to the fiberglass by conventional techniques such as, for example, air or airless spraying, padding, saturating, roll coating, curtain coating, beater deposition, and coagulation. For example, the binder can be applied to the glass fibers by flooding the collected mat of glass fibers and draining off the excess, by applying the binder composition onto the glass fibers during mat or blanket formation, by spraying the glass fiber mat or the like. As noted above, the layer of fiber with binder can then be mildly compressed and shaped into the form and dimensions of the desired insulation product such as pipe, batt or board and passed through a curing oven where the binder is cured, thus fixing the size and shape of the finished insulating product by bonding the mass of fibers one to another and forming an integral composite structure.

The aqueous binder, after it is applied to the glass fiber, is heated to effect drying and curing. The duration and temperature of heating will affect the rate of drying, processability and handleability, degree of curing and property development of the treated substrate. The curing temperatures are within the range from 75 to 300° C., preferably within the range from 90 to 250° C. and the curing time will usually be somewhere between 3 seconds to about 15 minutes.

When making fiberglass insulation, in particular, the drying and curing functions may be effected in two or more distinct steps, if desired. For example, the composition may be first heated at a temperature and for a time sufficient to substantially dry but not to substantially cure the binder composition and then heated for a second time at a higher temperature and/or for a longer period of time to effect curing. Such a procedure, referred to as “B-staging”, may be used to provide binder-treated product, for example, in roll form, which may at a later stage be cured, with or without forming or molding into a particular configuration, concurrent with the curing process. This makes it possible, for example, to use the compositions of this invention for producing binder-impregnated semifabricates which can be molded and cured elsewhere.

The glass fiber component will represent the principal material of the fiberglass insulation product. Usually 99-60 percent by weight of the product will be composed of the glass fibers, while the amount of binder solids will broadly be in reverse proportion ranging from 1-40 percent, depending upon the density and character of the product. Glass insulations having a density less than one pound per cubic foot may be formed with binders present in the lower range of concentrations while molded or compressed products having a density as high as 30-40 pounds per cubic foot can be fabricated of systems embodying the binder composition in the higher proportion of the described range.

Thus, in the broad practice of the present invention, fiber products can be formed as a relatively thin product, such as a mat having a thickness of about 10 to 50 mils; or they can be formed as a relatively thick product, such as a blanket of 12 to 14 inches or more. Fiber mat products of any thickness are embraced by the present invention. The time and temperature for cure for any particular fiber product will depend in part on the amount of binder in the final structure and the thickness and density of the structure that is formed and can be determined by one skilled in the art using only routine testing. For a structure having a thickness ranging from 10 mils to 1.5 inch, a cure time ranging from several seconds to 1-5 minutes usually will be sufficient at a cure temperature within the range of 175°-300° C.

Fiber mat products and especially products made from glass fibers may be used for applications such as, for example, insulation batts or rolls, as reinforcing mat for roofing or flooring applications, as roving, as microglass-based substrate for printed circuit boards or battery separators, as filter stock, as tape stock, as reinforcement scrim in cementitious and non-cementitious coatings for masonry and as facers for foam board or gypsum board. Other uses for thin fiber mats will also be recognized by those skilled in the art and the present invention is not to be limited to any specific end uses for the mat.

One surprising benefit observed as a consequence of the protein addition was a reduction in the free formaldehyde of the UF resin binder. Many of the freshly manufactured UF resins commercially used for making binders for fiber mats have a free formaldehyde content of about 1%. The soy-modified resins typically have a lower initial free formaldehyde. The free formaldehyde is typically below 0.5% for the soy protein-modified resin.

The following example is intended to be illustrative only and does not limit the scope of the claimed invention.

### EXAMPLE 1

In this example, glass mat hand sheets were prepared with glass fibers and binders prepared with the same UF resin and varying amounts of different additives, either a SMA copolymer and/or soy powder. The UF resin was a modified version of Georgia Pacific Resins, Inc.'s 2928 (made following the standard procedures of methylolation and condensation of urea and formaldehyde. In the soy-modified UF resin (designated as 309G63), the soy powder was added at the end of the UF resin synthesis. The soy-modified resin appeared to be homogeneous.

Mats (11 inch×11 inch handsheets) were prepared using a polyacrylamide whitewater and a fixed amount of glass fibers (approximately 6.3 grams)—Owens-Corning 9501 (one inch) glass fibers. Following mat formation, the mat was saturated with the respective binder formulations (diluted to 23% solids) and excess binder was removed by vacuum. The binder-treated mats then were cured for 35 and 45 seconds at 205° C. in a high airflow Werner-Mathis oven. Following the cure, strength and other properties of the consolidated mats were measured. Dry tensile strength and hot-wet tensile strength (by soaking the handsheets in 180° F. (82° C.) water for 10 minutes) were measured on a Thwing-Albert tensile tester (0-200 kg load cell). Tear strength (Elmendorf) was measured using a a Thwing-Albert Pro Tear tester (1.6 kg pendulum). The composition of the various binders tested and the tests results are summarized in Table 1 (35 second cure) and Table 2 (45 second cure). For each mat, seven replicates were run for each test. The hot-wet tensile is reported as the % retention (of dry tensile). The 95% confidence intervals were 59 gm-f for tear strength and 17 lbs for tensiles.

TABLE 1
(35 Sec. Cure Data)

| | Dry | | Tear | | |
|---|---|---|---|---|---|
| | Tensile | % | Strength | % | Basis Wt. |
| Binder Resin | (lbs) | Retention | (gm-f) | LOI | (lbs/100 ft²) |
| 1.5% SMA- | 100 | 67.5 | 304 | 23.7 | 1.85 |
| modified UF | | | | | |
| 1.0% Soy- | 89 | 84.3 | 304 | 22.3 | 1.82 |
| modified UF | | | | | |
| 1.0% Soy + 0.5% | 120 | 60.6 | 350 | 24.3 | 1.81 |
| SMA-modified UF | | | | | |
| 1.0% Soy + 1.5% | 109 | 71.0 | 366 | 22.2 | 1.85 |
| SMA-modified UF | | | | | |

TABLE 2
(45 Sec. Cure Data)

| | Dry | | Tear | | |
|---|---|---|---|---|---|
| | Tensile | % | Strength | % | Basis Wt. |
| Binder Resin | (lbs) | Retention | (gm-f) | LOI | (lbs/100 ft²) |
| 1.5% SMA- | 106 | 61.0 | 345 | 21.9 | 1.81 |
| modified UF | | | | | |
| 1.0% Soy- | 98 | 68.4 | 382 | 23.8 | 1.76 |
| modified UF | | | | | |
| 1.0% Soy + 0.5% | 106 | 71.1 | 395 | 24.0 | 1.79 |
| SMA-modified UF | | | | | |
| 1.0% Soy + 1.5% | 108 | 71.5 | 341 | 22.5 | 1.84 |
| SMA-modified UF | | | | | |

Mats made with the soy modifier exhibited acceptable tear and tensile properties.

### EXAMPLE 2

In this example, glass mat hand sheets were prepared with glass fibers and binders prepared with the same base UF resin and varying amounts of different additives, either a SMA copolymer, soy powder, or the combination of SMA and soy. Both base UF resins were modified versions of Georgia Pacific Resins, Inc.'s 2928 made following the standard procedures of methylolation and condensation of urea and formaldehyde. All the soy-modified and soy/SMA-modified resins appeared to be homogeneous. UF1 was similar to 309G63 (with various levels of soy as shown in the following table) and UF2 was similar to GP-2928 (with various levels of SMA).

Mats (11 inch×11 inch handsheets) were prepared using a polyacrylamide whitewater and a fixed amount of glass fibers (approximately 6.3 grams)—Owens-Corning 9501 (one inch) glass fibers. Following mat formation, the mat was saturated with the respective binder formulations (diluted to 23% solids) and excess binder was removed by vacuum. The binder-treated mats then were cured for 35 and 45 seconds at 205° C. in a high airflow Werner-Mathis oven. Following the cure, strength and other properties of the consolidated mats were measured. Dry tensile strength and hot-wet tensile strength (by soaking the handsheets in 180° F. (82° C.) water for 10 minutes) were measured on a Thwing-Albert tensile tester (0-200 kg load cell). Tear strength (Elmendorf) was measured using a Thwing-Albert Pro Tear tester (1.6 kg pendulum. The composition of the various binders tested and the tests results are summarized in Table 3. For each mat, seven replicates were run for each test. The hot-wet tensile is reported as the % retention (of dry tensile). The 95% confidence intervals were 63 gm-f for tear strength and 14 lbs for tensiles.

TABLE 3

| | | | | | | |
|---|---|---|---|---|---|---|
| | Cure time | Dry Tensile | | Tear | | BW |
| Binder Resin | (sec) | (lbs) | % Retention | (gm-f) | % LOI | (lbs/100 ft²) |

Soy added during condensation reaction

| | | | | | | |
|---|---|---|---|---|---|---|
| 1.0% Soy-modified UF1 | 35 | 78 | 65.1 | 672 | 21.1 | 1.84 |

Soy added as back add

| | | | | | | |
|---|---|---|---|---|---|---|
| 0.5% Soy-modified UF1 | 45 | 77 | 66.2 | 571 | 23.0 | 1.84 |
| 1.0% Soy-modified UF1 | 45 | 99 | 67.2 | 631 | 22.9 | 1.84 |
| 2.0% Soy-modified UF1 | 35 | 86 | 64.8 | 613 | 23.6 | 1.85 |
| 3.0% Soy-modified UF1 | 45 | 88 | 59.6 | 695 | 24.7 | 1.84 |
| 1% Soy/1.0% SMA-modified UF1 | 45 | 88 | 65.8 | 594 | 21.8 | 1.83 |

SMA-modified UF resins

| | | | | | | |
|---|---|---|---|---|---|---|
| 1.0% SMA-modified UF1 | 45 | 84 | 79.4 | 576 | 22.21 | 1.84 |
| 2.0% SMA-modified UF1 | 45 | 84 | 78.4 | 704 | 20.39 | 1.83 |

Controls

| | | | | | | |
|---|---|---|---|---|---|---|
| 2.0% SMA-modified UF2 | 35 | 78 | 67.2 | 512 | 20.77 | 1.81 |
| 1.0% SMA-modified UF2 | 45 | 80 | 70.8 | 471 | 21.03 | 1.80 |
| 8.0% latex-modified UF1 | 35 | 84 | 69.9 | 512 | 19.63 | 1.80 |

As the concentration of the soy was increased from 0.5 to 3% in the modified UF resins, the dry tensile and tear strength increased for mat produced at similar % retentions. All of the mats made with the soy-modifications yielded acceptable tear and tensile properties. The binder with 1% soy back added to the UF had the best overall properties and was improved over the controls.

While the invention has been described with reference to certain preferred embodiments, and exemplified with respect thereto, those skilled in the art will appreciate that various changes, substitutions, modifications and omissions may be made without departing from the spirit of the invention. Accordingly, it is intended that the scope of the present invention be limited solely by that of the following claims. Unless otherwise specifically indicated, all percentages are based on UF resin solids. Throughout the specification and in the claims the term “about” is intended to encompass + or −5%.

1. A binder composition comprising a urea-formaldehyde resin, prepared at a formaldehyde to urea mole ratio in the range of about 2.1:1 to 3.2:1, modified with a protein, said protein provided in an amount of 0.1% to 10% by weight of urea-formaldehyde resin solids.

2. The binder composition of claim 1 wherein the protein is a vegetable protein.

3. The binder of claim 2 wherein the vegetable protein is a soy protein.

4. The binder of claim 3 wherein the soy protein is a soy flour and having a final formaldehyde to urea mole ratio in the range of about 1.4:1 to about 2.3:1.

5. The binder of claim 4 having the soy flour in an amount of about 0.2% to about 7% by weight of urea-formaldehyde resin solids.

6. The binder of claim 1 comprising a binder modifier selected from the group consisting of a styrene-maleic anhydrde copolymer; a non-ionic amine oxide, optionally with a latex or a water-soluble polymer; a water-insoluble anionic phosphate ester and a fatty alcohol; and a styrene/acrylate/acrylonitrile polymer, supplemented with a polysiloxane.

7. A fiber mat bonded with a binder composition comprising a urea-formaldehyde resin modified with a protein, said protein provided in an amount of 0.1% to 10% by weight of resin solids.

8. The fiber mat of claim 7 wherein the protein is a vegetable protein.

9. The fiber mat of claim 8 wherein the vegetable protein is a soy protein.

10. The fiber mat of claim 9 wherein the soy protein is a soy flour.

11. The fiber mat of claim 10 having the soy flour in an amount of about 0.2% to about 7% by weight of urea-formaldehyde resin solids.

12. The fiber mat of claim 11 made using glass fibers.

13. The fiber mat of claim 7 wherein the binder comprises a binder modifier selected from the group consisting of a styrene-maleic anhydrde copolymer; a non-ionic amine oxide, optionally with a latex or a water-soluble polymer; a water-insoluble anionic phosphate ester and a fatty alcohol; and a styrene/acrylate/acrylonitrile polymer, supplemented with a polysiloxane.

14. A process for making a fiber mat comprising (a) forming an aqueous dispersion of fibers; (b) passing the dispersion through a mat forming screen to form a wet non-woven mat and (c) applying a binder composition to the wet non-woven mat, the binder composition comprising a urea-formaldehyde resin modified with a protein, said protein provided in an amount of 0.1% to 10% by weight of resin solids.

15. The process of claim 14 wherein the protein is a vegetable protein.

16. The process of claim 15 wherein the vegetable protein is a soy protein.

17. The process of claim 16 wherein the soy protein is a soy flour.

18. The process of claim 17 having the soy flour in an amount of about 0.2% to about 7% by weight of urea-formaldehyde resin solids

19. The process of claim 18 wherein the fibers are glass fibers.

20. The process of claim 14 wherein the binder comprises a binder modifier selected from the group consisting of a styrene-maleic anhydrde copolymer; a non-ionic amine oxide, optionally with a latex or a water-soluble polymer; a water-insoluble anionic phosphate ester and a fatty alcohol; and a styrene/acrylate/acrylonitrile polymer, supplemented with a polysiloxane.
